(19) United States
(12) Patent Application Publication
(10) Pub. No.: US 2014/0357192 A1
(43) Pub. Date: Dec. 4, 2014

(54) SYSTEMS AND METHODS FOR CONNECTIONLESS PROXIMITY DETERMINATION

(71) Applicants: TAL AZOGUI, Petach Tikva (IL); ROY RAMON, Hod Hasharon (IL); RAZ WEIZMAN, Beer Sheva (IL)

(72) Inventors: TAL AZOGUI, Petach Tikva (IL); ROY RAMON, Hod Hasharon (IL); RAZ WEIZMAN, Beer Sheva (IL)

(21) Appl. No.: 13/909,538

(22) Filed: Jun. 4, 2013

(51) Int. Cl. G01S 5/02; H04B 7/26

(52) U.S. Cl. CPC G01S 5/0289; H04B 7/26
USPC 455/41.2

(57) ABSTRACT

A method of determining proximity of Bluetooth/Bluetooth Low Energy (BT/BLE) devices, in a connectionless session includes executing a contiguity profile at a first device, the contiguity profile providing for connectionless proximity determination. The method further includes determining a proximity of a second device using Bluetooth/Bluetooth Low Energy (BT/BLE) protocol without establishing a Bluetooth/Bluetooth Low Energy (BT/BLE) connection to the second device.

### TECHNICAL FIELD

Embodiments described herein generally relate detecting proximity using Bluetooth/Bluetooth Low Energy (BT/BLE) systems.

### BACKGROUND

Bluetooth/Bluetooth Low Energy (BT/BLE) systems are popular ways of providing connectivity between mobile devices and a variety of systems, such as cars, exercise devices, computers, tablets, etc. Currently, BT/BLE systems are governed by the Bluetooth 4.0 specification. BT/BLE systems rely on first establishing a connection between two paired devices in order to exchange data. Subsequently, a variety of information may be exchanged between devices.

### BRIEF DESCRIPTION OF THE DRAWINGS

FIG. 1 shows a diagram is current BT/BLE proximity;

FIG. 2 shows a diagram of an example of current Proximity solution;

FIG. 3 shows a diagram of an example of current Proximity solution when new devices attempt to join the protocol;

FIG. 4 shows one embodiment of a system for Connectionless Proximity Determination;

FIG. 5 shows one embodiment of a multiple proximity system;

FIG. 6 shows a diagram of one embodiment of flow for proximity connection to a mobile device;

FIG. 7 shows a diagram of one embodiment of a device calculating proximity to multiple other devices; and

FIG. 8 shows an example of interfaces and indicators for a system utilizing a system of Connectionless Proximity Determination.

### DETAILED DESCRIPTION OF THE DRAWINGS

Described herein are embodiments of systems and methods for Connectionless Proximity Determination. Generally, the Bluetooth specification provides for proximity communication only when one device is connected to another. Furthermore, proximity is communicated from the Slave to the Master device in a one way fashion under current specifications. Greater flexibility is desired for proximity determination, which systems and methods for Connectionless Proximity Determination generally provide for by providing a connectionless profile that allows for proximity to be measured.

Current BT/BLE proximity requires a connection between the devices. It suffers 3 main issues:

1. The proximity protocol is a connection dependent protocol. This means that before initiating the proximity protocol the two devices have to generate a connection between them, agree on all connection parameters, and only then initiate the proximity protocol between them. The establishment of such a connection is rather a long process which requires parameters swapping and can be done only with previously known (also known as paired) BLE devices.

If the connection for some reason is lost the proximity protocol is immediately stopped and can continue only after a reconnection between the devices. In the meantime the proximity protocol won't be active and the devices won't be able to get the proximity of the other.

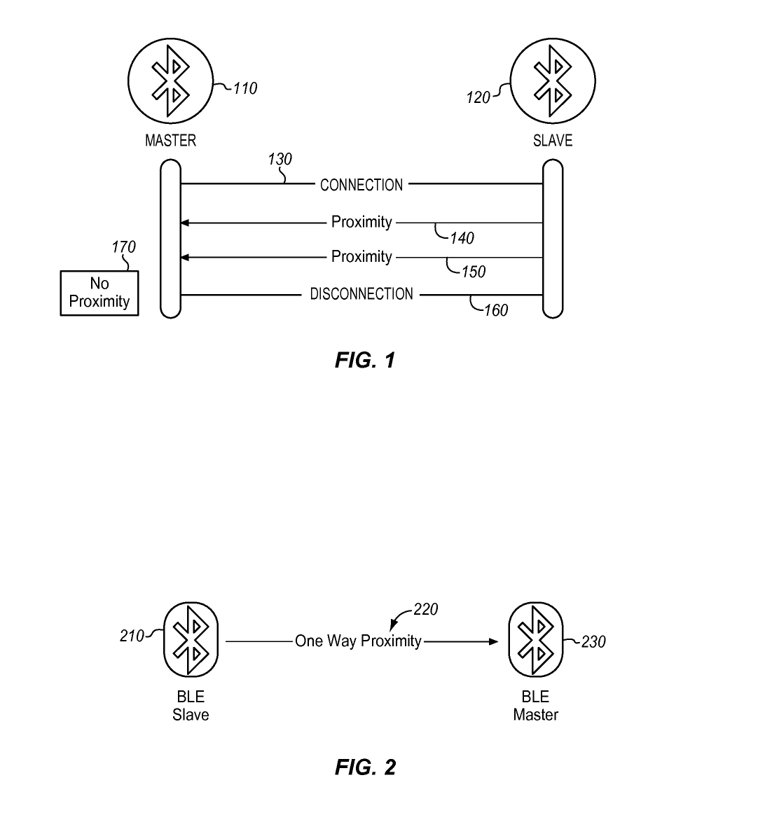

FIG. 1 shows a diagram is current BT/BLE proximity. Master device 110 communicates with Slave device 120 by first establishing a connection 130. Subsequently, proximity messages 140, 150 may be sent from Slave device 120 to Master device 110. If there is a disconnection 160, no proximity 170 may be conveyed.

2. Current Bluetooth (BT) or Bluetooth Low Energy (BLE) proximity protocol (Based on Bluetooth 4.0 specification) is conducted using two devices, where one of them acts as a Master in the connection and a Monitor as a consequence and the second device performs as a Slave and a Reporter. Hence, the proximity role has to match the role in other BLE connections. That means that a device cannot be a Slave (Reporter) in the proximity protocol and a Master in another protocol. The Master\Slave role has to be the same for all BLE active profiles on a device

The following table represents the only allowed combination of BLE and proximity set of roles:

TABLE 1
Roles and Proximity

| Proximity role/BLE role | Master | Slave |
|---|---|---|
| Monitor | Yes | No |
| Reporter | No | Yes |

3. The currently specified proximity protocol is conducted only between two devices. The BLE frame of the protocol is a unicast frame and each device that would like to join the proximity protocol will have to establish a connection with each device and start a separate proximity protocol with it. In many cases this cannot be done due to roles policy which states that a device can't be allocated in both Master and Slave roles. The method also takes a lot of resources and doesn't really allow a group of BLE devices to conduct a proximity protocol between them.

A diagram showing an example of current Proximity solution is shown in FIG. 2. BLE Slave 210 may communicate one-way proximity 220 to BLE Master 230. This means that Master 230 may not communication proximity back to Slave 210. The proximity is sensed only on one direction from the BLE salve functioning as the proximity Reporter to the BLE Master functioning as the proximity Monitor.

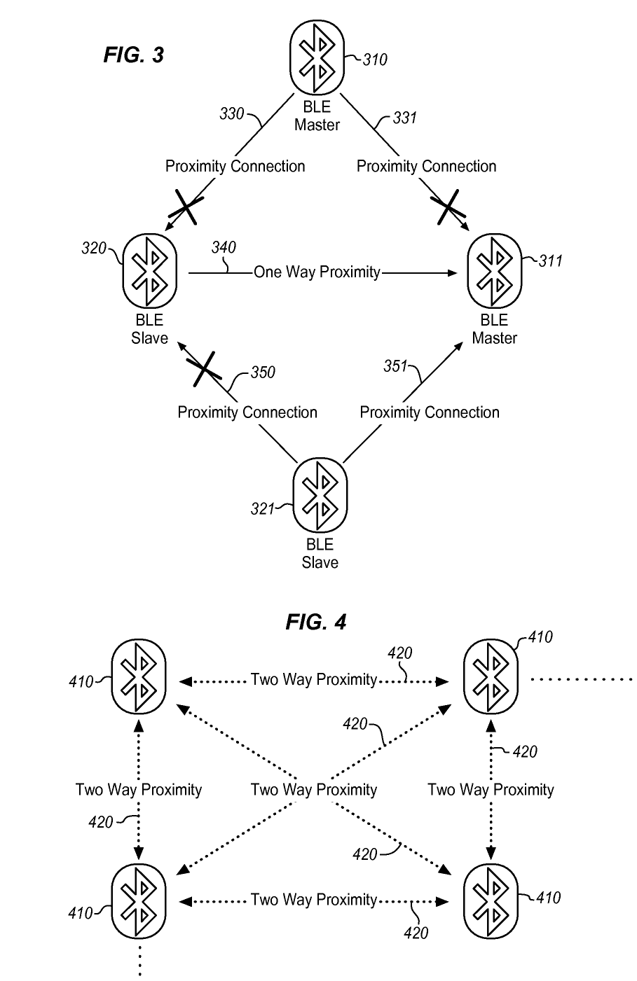

When new nodes will attempt to join the Proximity session only one type of connection can succeed. FIG. 3 shows a diagram of an example of current Proximity solution when new devices attempt to join the protocol. Master 310 may not create a Proximity connection 330, 331 with either Slave 320 or Master 311. This is because Master 310 is a Master and may not server a Reporter function. Slave 320 is providing one-way proximity 340 to Master 311. Here a connection has already been made between the two devices. Slave 321 may not create proximity connection 350 between it and Slave 320, since a Slave cannot be a Monitor. Slave 321 may create a proximity connection 351 with Master 311 (and Master 310), but only after a connection is established. Currently, there are no connectionless solutions for BT/BLE proximity. Hence all current solutions suffer from the same issues described above.

In contrast to current solutions, embodiments of systems and methods for Connectionless Proximity Determination are provided. These embodiments include a Contiguity Profile, created in order to establish the connectionless oriented proximity protocol.

In embodiments of systems and methods for Connectionless Proximity Determination all Proximity can be sensed as Multi-Directional Proximity, between every two or more BLE nodes in range. No prior connection has to be established between the nodes. It doesn't matter if the BLE node is a Master or a Slave in other already established BLE or BT connections. The systems and methods for Connectionless Proximity Determination can take place between any two BLE device roles—Master to Master, Master to Slave and Slave to Slave. In addition, a device can be both a Proximity Reporter and a Proximity Monitor concurrently. As a consequence, the Proximity is a multipoint to multipoint protocol.

FIG. 4 shows one embodiment of a system for Connectionless Proximity Determination. Devices 410 may execute two-way proximity with any of the other devices 410 as long as they are in range. In contrast to the BLE proximity profile, there is no connection limitation. A device can analyze proximity to any number of devices, in its radio range.

Contiguity Profile (CGP)

Aspects of the CGP are described below. In many configurations, existing BT/BLE devices may implement the CGP and thereby provide connectionless proximity determination, while still connecting to other BT/BLE devices.

Dependency—The CGP profile is independent of other GAP (Generic Access Profile) profiles. It doesn't require a connection between the peers or the SDP (Service Discovery Protocol) prior to using it.

Conformance—The profile provides for the implementation of both roles, the Reporter and the Monitor. If conformance to this profile is claimed, all capabilities indicated as mandatory for this profile may be supported in the specified manner (process-mandatory). This also applies for all optional and conditional capabilities for which support is indicated.

Roles—The CGP defines two roles:

1. Reporter—the Reporter will advertise itself with BLE advertisement messages

2. Monitor—the Monitor will scan for advertisement messages and will calculate the proximity according to these messages.

Topology—Since there is no active connection between the peers, the profile topology is flexible. Both devices that are communicating may be in either Master (central for GATT (Generic Attribute Profile)) or Slave (peripheral for GATT) roles. The differentiation is in the modes of advertisement and scanning in each role and scenario.

1. Master to Master: when both Masters are using the BLE CGP, assuming one is the Reporter and the other is the Monitor (both devices can do both roles) a connection won't be established as long as the following conditions are implemented:

a. The Reporter may advertise only non-connectable advertisement messages.
b. The Monitor may be either in passive scanning or active scanning.

Following these conditions the two devices may still accept other connections and continue to function as Masters.

2. Master to Slave: when the BLE CGP is in use between a Master and a Slave, there may be two different cases:

a. No connection is established between Master and Slave, there are two sets of optional configurations:
i. The Reporter advertises a non-connectable advertisement and the Monitor performs either passive scanning or active scanning. This mode allows the Master to let other devices connect to it.
ii. The Reporter will advertise either connectable directly or indirectly and the Monitor will perform only passive scanning. This mode allows the Slave to connect to other devices as well.
b. A connection is established between Master and Slave:
i. The Reporter will advertise a connectable advertisement and the Monitor will be in initiator state.

3. Slave to Slave: when the BLE CGP is in use between two Slaves (no connection between them is possible). Therefore the Reporter may use either non-connectable or connectable advertisement and the Monitor may be required to use passive scanning.

The connection matrix is shown in Table 2:

TABLE 2
Connection Matrix

| | Reporter | |
|---|---|---|
| Monitor | Master | Slave |
| Master | Advertise - non-connectable | Advertise - non-connectable |
| | Scanning - Active or passive | Scanning - Active or passive |
| | Connection - N/A | Connection - N/A |
| Slave | Advertise - non-connectable | Advertise - Any |
| | Scanning - 1. Active | Scanning - Active or passive |
| | 2. Passive | Connection - N/A |
| | Connection - not enabled | |
| | Advertise - connectable | |
| | Scanning - Active or passive | |
| | Initiating - Active | |
| | Connection - enabled | |

Each device has to have one of the roles—Reporter or Monitor in order to use this profile. In contrast to prior proximity methods, a device may also have both roles however.

Service Discovery—In many configurations, the roles and topology may respect the service discovery definitions and conditions according to the BLUETOOTH SPECIFICATION Version 4.0 [Vol. 3]. The short set of rules matching this profile is:

1. The Reporter can be in one of the three discoverable modes. For the non-discoverable mode the advertising messages may be either non-connectable or non-scannable undirected.
2. The Reporter device in the limited discovery mode may send non-connectable, scannable or undirected advertisement messages.
3. The Reporter device in the general discoverable mode may send non-connectable, scannable, or undirected advertisement messages.
4. For a Master performing limited discovery procedure and the general discovery procedure the Host shall set the scanner filter policy to ‘process all advertising packets’.

Concurrency—A device may implement a CGP Monitor or a CGP Reporter together with other profiles at the same time. A device may also implement both a CGP Monitor and CGP Reporter at the same time.

Tx Power—The Tx power (transmission power) of the advertisement messages may not change throughout the entire process of this profile. This parameter is a factor in the CGP and therefore any change of the Tx power will result in CGP performance degradation. Generally, the proximity may be calculated according to the loss of transmission power.

Connection Establishment—The CGP doesn't require a connection along all of its operational flow. A connection desired between a CGP peer and other devices may be permitted according to the service discovery and topology conditions detailed in earlier sections.

Setup of a CGP profile—In order to begin the use of the CGP there may be a need to set the parameters manually (not relying on SDP (Service Discovery Protocol) to setup the profile). To set the profile two parameters may be matched:

1. Other device BD address—each device may know the other device BD address (Bluetooth Device address).

2. Authentication key—both devices need to agree on a pre-shared key. (Only for authentication) This authentication key may be not needed for CGP profile activities, only when the devices connected in an authenticated session.

Multipoint to Multipoint—The CGP can work in a multipoint to multipoint setup where each device functions as a Monitor, Reporter or both and since no pairing may be needed all the devices can attend the CGP together. This mode of operation will cause each Monitor to calculate to proximity of any Reporter to it and allows a Reporter to broadcast an advertisement to all Monitors around it.

CGP Profiles and Uses

Many different modes of operation are available for providing increased functionality when using the CGP profile. Many of the use cases described herein are derived out of the BLE proximity sensor and its ability to keep its operation as a proximity sensor even when the devices are connected by definition to other devices.

Distance Thresholds Modes

In distance threshold modes, the differences in distances thresholds between the two BLE devices are described. The number of thresholds can vary according to the use case and also the firmness of the threshold.

Enable/Disable Threshold—This mode describes a use case when only one distance threshold may be at use. When the proximity for a device reaches the distance threshold a proximity event may be triggered. When the proximity decreases away from the distance threshold a second event may be triggered. In addition it may be possible to add a firmness factor into the use case. This means that the proximity decrease event won't happen exactly where the proximity increase event occurred but rather at a second distance. As an example: the proximity increase event occurs at 1.5 meters and the proximity decrease event occurs at 4 meters. The enable/disable threshold mode applies to use cases where there may be one threshold such as lock-unlock or dock-undock and no alerting for several proximity levels between the devices.

Service Quality—This mode describes use cases where there may be a use for three different distance proximity thresholds or more. This means that the system will give a different callback for each of the proximity thresholds. These thresholds may be at least 3 meters apart from each other in order to give the algorithm the operating space it needs, so implementing more than 3 proximity ranges may be challenging considering BLE range. The mode may be able to support any gradual process where several proximity thresholds are in use. In this way a system or process may be gradually started or advanced. The Service Quality mode applies to scenarios where there may be a need to make a gradual process of wake on BT or to stop any other hardware sleep.

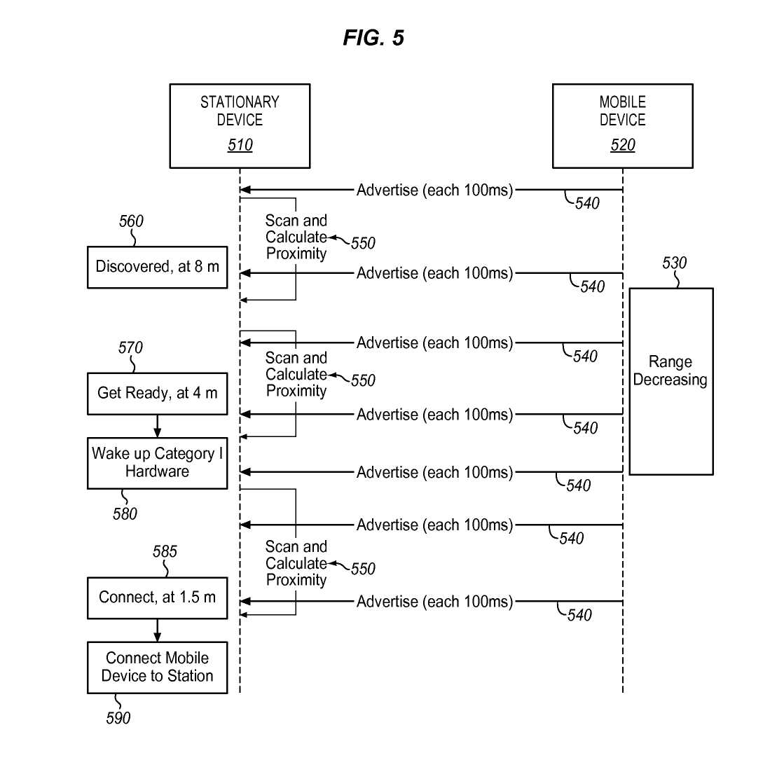

FIG. 5 shows one embodiment of a multiple proximity system. Stationary device 510 may be approached by mobile device 520 and the range 530 may be gradually decreased. Mobile device 520 may be a Reporter and sends advertisements 540 every 100 ms. Stationary device 510 may be a Monitor and it scans and calculates proximity 550. At a distance of 8 m 560, mobile device 520 may be discovered. At 4 m 470 stationary device 510 gets ready for connection. Stationary device 510 wakes up category 1 hardware 580. At a distance of 1.5 m 585 a connection may be made. The mobile device 520 connects 590.

Only Enable Threshold—This mode describes situations where there may be only a proximity increase event trigger and proximity decrease event trigger. When the proximity increase threshold may be achieved, the trigger activates the event and no more activity from the proximity sensor will occur. The only enable mode applies to use cases where there may be only a connecting event and the disconnecting will be made in some other means

Hand-Off Communication Modes

These modes describe the communications that receive context after the proximity has been reached either prior to authentication or after the authentication process.

CCF—This mode defines use cases where after the proximity threshold has been reached by the BLE the CCF (Closed Communication Function) will come to action and any communication other than the proximity maintenance will be managed by the CCF. The CCF mode applies to use cases where the BLE may be used to trigger the proximity event between two devices and then there may be a need to establish a connection in order to pass some sort of data, audio, video, etc., such as wireless docking.

WiGig—This WiGig mode defines use cases where after the proximity threshold has been reached by the BLE the WiGig will come to action and any communication other than the proximity maintenance will be managed by the WiGig. This may be used for wireless docking with the WiGig technology where after the proximity threshold has been reached the WiGig functions as a connection.

WiDi—This mode defines use cases where after the proximity threshold has been reached by the BLE the WiDi protocol may be initiated between the two devices. The WiDi mode applies to use cases where a mobile device searches for a WiDi connection. After the proximity has been reached between the mobile device and the WiDi device the WiDi protocol will initiate between the two.

None—This mode defines use cases when there may be no need to hand-off any communication to other types of technology. When the proximity trigger has been reached, no other type of communication occurs and the BLE proximity may continue or cease. No hand-off communication mode applies to use cases where there may be no need to transfer any data between the two BLE proximity devices other than the proximity protocol.

Discoverability Modes

Each discoverability mode may implement the service discovery requirements detailed in the profile requirements. Exceptions from these requirements may violate the current Bluetooth specification. As specifications evolve, these parameters may change. The modes detailed here are the extension of these requirements and focus on the period interval and window of each operation.

Advertisement: In many configurations, for an advertisement interval the minimum interval value may not be smaller than 20 ms. The use of an interval less than 20 ms can cause slow performance. Normal use occurs at an advertisement interval of 80 ms and may be fast enough to track normal movement of an individual. Advertisement intervals bigger than 150 ms will cause poor performance in the proximity algorithm for the distance calculations at the stationary device. In this mode, as long as the desired advertise interval may be above 20 ms, the parameter values min interval and max interval may be equal to the desired advertisement interval. If the desired interval may be lower than 20 ms than the min interval and max interval may be set with 20 percent difference. In any case an advertise interval less than 10 ms may not be allowed.

Scanning: For the scanning interval and window, the optimum values may be equal values in both parameters. Otherwise, the Monitor device to perform might perform a never ending scan and block all other data transferring. If the values are not equal we set a new parameter named scanning percent that may be calculated by the scanning interval/scanning window. It describes the percent of the time during the scan may be operated. In normal operation, the parameters of scanning interval and window depend on the advertising rate. Assuming an advertisement interval of 100 ms, the scanning percentage may be at least 80 percent and the scan window may not be bigger than 200 ms. While the advertising interval increases the scanning percentage any decrease down to 60 percent (in an advertisement interval of about 40 ms). Less than that may cause poor performance in the proximity calculation.

Steady advertise and scan (Fixed schedule)—This mode defines use cases where both the advertise interval and the scan interval and window do not change along the entire runtime of the use case. It means there after the parameters are set there will be no additional changes to these parameters. Furthermore, by using this mode the parameters are set to be unchangeable for a period of time. The steady advertisement and scan mode applies to use cases where the proximity calculations have to be kept both for the first step of proximity increasing and in the second step of proximity maintaining with no change of relevance and importance of the proximity calculation. For example it can fit to wireless docking where the drawing away from the dock may be important as docking.

Changing and Setting New Frequency—This mode may be similar to the requirements as described the previous mode. The difference in this mode may be that at a certain point, the use case asks for a different importance for the proximity. When this occurs, the advertisement interval can decrease and so can the scanning percentage (defined in the previous mode). Both the new frequency and the old one, before the change, may be bound by the rules of advertisement and scanning. The change can be made from any set of advertisement and scanning configuration to any other set as long as they both fit the requirements. The changing and setting new frequency mode applies to use cases where the proximity calculation may be more flexible and can change at a certain point. This means that after a proximity event the frequency of the proximity calculation may be changed to either to a more frequent algorithm or less frequent one. For example it can work with a WiDi connection where after the initial connection to the WiDi, the frequency of proximity calculation between the devices may be reduced.

Examples of Use

Provided are various use cases for BLE proximity on mobile devices. These examples demonstrate the proximity modes by choosing the correct settings for best performance. These use cases are general purpose and can be extended with any selection of the modes above.

WiDi Connecting—This use case enables the mobile BLE device to gradually prepare itself for a wireless connection between the mobile device and the WiDi device. In this way most resources of the mobile device can be turned off and gradually activated as the proximity between the two increases. In this use case the proximity will be the determining factor which will save energy consumption and valuable connecting time.

Communicating components—In this use case the components communicating may be the mobile BLE device which wants to establish the connection to the WiDi and the WiDi device.

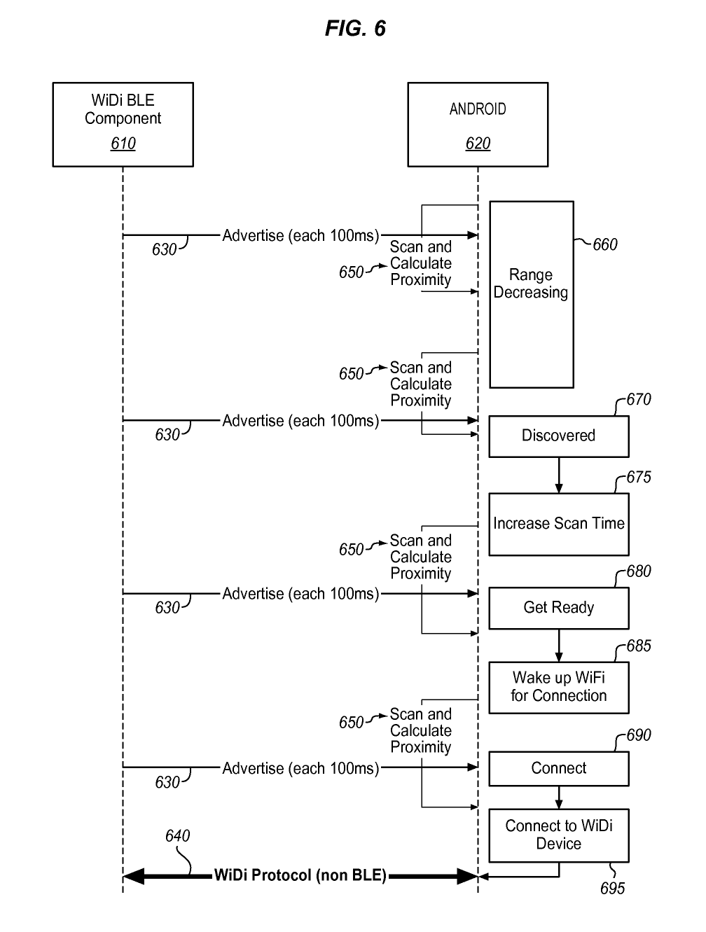

Operational Flow—In this use only the stationary WiDi device may be the Reporter and its advertising itself in order for the mobile device—the Monitor will be able to calculate proximity to it. FIG. 6 shows a diagram of one embodiment of flow for proximity connection to a mobile device. WiDi BLE Component 610 communicates with mobile device 630 (in this case an Android device) by sending advertisements 630. Device 620 scans and calculates proximity 650 based on the advertisements 630. As the range decreases 660, the device 620 takes certain start-up and connection actions. In step 670 the WiDi BLE Component 610 may be discovered. The Device 620 increases the frequency of scans in response in step 675. When the device gets closer yet, gets ready 680 and wakes up the WiFi connection capabilities 685. Finally, when device 630 may be at the proper proximity, it begins to connect 690 and finally connects to the WiDi device 695. A WiDi Protocol connection 640 then provides for data transfer.

Data Exchange—In this use case there isn't real BLE data exchange between both devices. The only data between the devices may be the advertisement messages broadcasted. The WiDi device sends its own advertisement messages to the mobile device so that it may calculate the range and modify its connection state. Since the devices do not need to be “connected” in the sense of a completed BLE connection, the data exchange may be minimal. In an alternative, additional data may be added to the advertisement messages that will include some kind of identification of the device in order to know the exact capabilities of the WiDi device. This may be device information, an estimate data transfer rate that the device may be capable of, or other information about the protocol used.

Abstract use case mapping—Mapping between the abstract proximity modes and this use case can be viewed in Table 3:

TABLE 3
Proximity mode mapping for WiDi.

| Mode | Option(s) | Notes |
|---|---|---|
| Distance | Service | Defines three thresholds for discovery, |
| threshold | quality | get ready and connect |
| Hand-off | WiDi | When there may be a recommendation to |
| communication | | connect according to the proximity the |
| | | WiDi protocol will initiate |
| Discoverability | Changing | After connecting to the WiDi the |
| | | advertising frequency can decrease |

Coexistence with other BLE profiles—This use case can coexist with other BLE profiles as long as it keeps the following requirements:

Mobile device—Monitor:

1. Can be either in Master or Slave mode;
2. Scanning window may be between 100 to 200 ms;
3. Scanning percent may be above 70%; and
4. If the Monitor may be at initiating state the Reporter can't use connectable advertisement messages.

WiDi station—Monitor:

1. Can be in either Master or Slave mode;
2. Advertising at a constant interval of up to 100 ms (recommended may be 80 ms);
3. After connecting the advertising can drop to an interval of 150 ms;
4. Can advertise non-connectable, non-scannable and connectable undirected messages; and
5. If in initiating state then the Reporter can't use connectable advertisement messages.

Environment Service Discovery

This use case enables any device to scan its own environment for other advertising BLE devices and to discover any services around it. In this way each device may be able to discover all devices near it and the service each device offers without the need to pair and even without the need to reveal itself. This may be different from normal BLE service discovery in that the device may calculate the range to each other device and then may pick the closest or most optimal devices for connection.

Communicating components—The communicating devices in this use case are an Android mobile device acting as a Monitor and every advertising BLE device acting as a Reporter. The mobile device receives the advertising messages of all BLE devices near it and can receive the general classification of the device and calculate the range to that device.

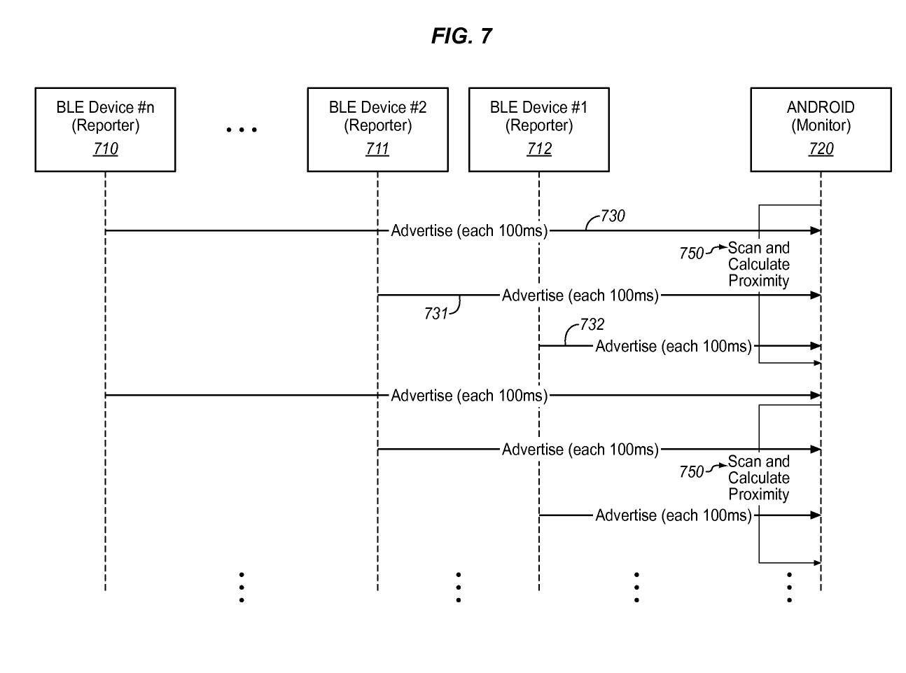

Operational Flow—Each BLE device advertises itself to the mobile Android device. FIG. 7 shows a diagram of one embodiment of a device calculating proximity to multiple other devices. Reporter devices 710, 711, 712 (etc.) each send advertising messages 730, 731, 732 to Monitor 720. Monitor 720 scans and calculates the proximity 750 to Reporter devices 710, 711, 712. Monitor 720 may then use the information concerning proximity and what devices may be available in order to determine the optimal connection.

Data Exchange—The data exchanged in this use case may be the advertisement messages sent from the BLE service devices and the mobile device.

Abstract use case mapping—Mapping between the abstract proximity modes and this use case can be viewed in Table 4:

TABLE 4
Use case mapping for proximity.

| Mode | Option(s) | Notes |
|---|---|---|
| Distance | 1. Service quality - | When using one threshold both |
| threshold | a threshold for | authentication and docking will |
| | connection state | occur at this threshold |
| | between the Reporter | |
| | and the Monitor | |
| Hand-off | None | No hand-off to other |
| communication | | communication type |
| Discoverability | Steady | Advertisement interval doesn't |
| | | change |

Coexistence with other BLE profiles—This use case can coexist with other BLE profiles as long as it keeps the following requirements:

Mobile device—Reporter:

1. Can be either in Master or Slave mode;
2. Advertising at a constant interval of up to 100 ms (recommended is 100 ms);
3. Can advertise non-connectable, non-scannable and connectable undirected messages;
4. If the Monitor is at initiating state the Reporter can't use connectable advertisement messages.

Station—Monitor:

1. Can be in either Master or Slave mode;
2. Scanning window may be 200 ms;
3. Scanning percent may be above 75%; and
4. If in initiating state then the Reporter can't use connectable advertisement messages.

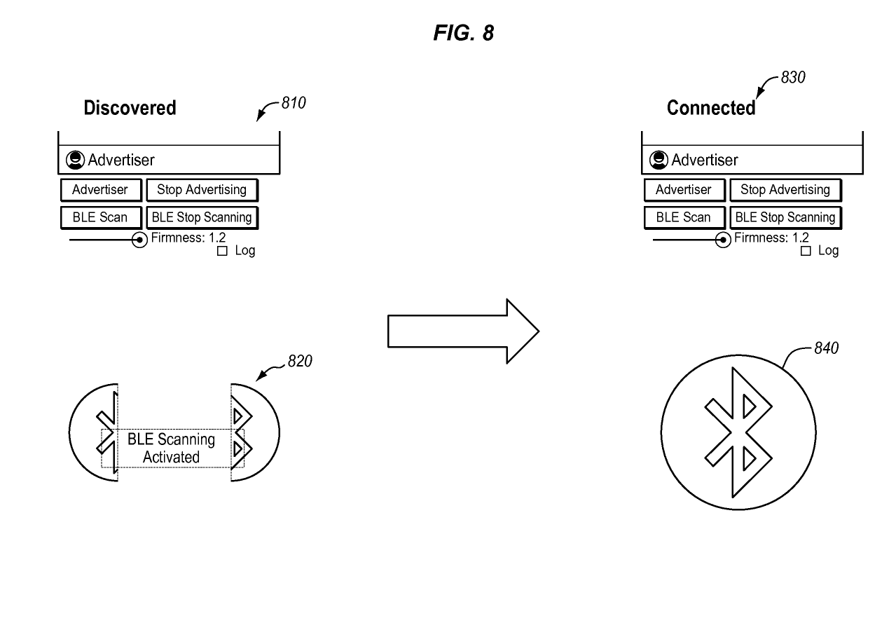

FIG. 8 shows an example of interfaces and indicators for a system utilizing a system of Connectionless Proximity Determination. Screen 810 shows an interface for a BLE scanning activated advertiser and indicator 820 indicates that scanning is occurring. Screen 830 shows an interface for a BLE connected system and indicator 840 indicates connection.

Many examples of use cases are described herein related to embodiments of systems and methods for Connectionless Proximity Determination. These use cases are merely exemplary and in many cases may be implemented together or in a segmented fashion. Furthermore, these use cases are merely exemplary and in many cases relate to the current Bluetooth specifications. As Bluetooth specifications change, it will be apparent to one of ordinary skill in the art how the use cases may change in light of the detailed information provided in this disclosure.

Various embodiments of systems and methods for Connectionless Proximity Determination may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

In one embodiment, a method of determining proximity of Bluetooth/Bluetooth Low Energy (BT/BLE) devices, in a connectionless session includes executing a contiguity profile at a first device, the contiguity profile providing for connectionless proximity determination. The method further includes determining a proximity of a second device using Bluetooth/Bluetooth Low Energy (BT/BLE) protocol without establishing a Bluetooth/Bluetooth Low Energy (BT/BLE) connection to the second device. Optionally, the contiguity profile provides multidirectional proximity. In one configuration, the contiguity profile specifies that the first device is a proximity Reporter and a proximity Monitor concurrently. In another configuration, the contiguity profile specifies that as a proximity Reporter the first device advertises with advertisement messages and that as a proximity Monitor the first device scans for advertisement messages and determines proximity based on advertisement messages. In one alternative, the first device functions as the proximity Monitor and receives an advertisement message from the second device and based on the advertisement message performs the determining. Optionally, the first device functions as the proximity Reporter sends an advertisement message to the second device and based on the advertisement message, the second device performs the determining. In another alternative, the first device simultaneously functions as the proximity Reporter sends an advertisement message to the second device and based on the advertisement message, the second device performs the determining. Optionally, the method further includes triggering a first proximity event when the proximity is less than a first proximity threshold. Alternatively, the method further includes triggering a second proximity event when the proximity is greater than a second proximity threshold. Optionally, the first proximity event is the activation of a system in the second device and the second proximity event is the deactivation of the system in the second device. In one alternative, the method includes triggering a first proximity event when the proximity is less than a first proximity threshold; triggering a second proximity event when the proximity is less than a second proximity threshold; and triggering a third proximity event when the proximity is less than a third proximity threshold; the second proximity threshold is closer to the second device than first proximity threshold and the third proximity threshold is closer to the second device than the second proximity threshold, and the first, second, and third proximity event relate to a wake up and activation of the second device. Optionally, the method includes triggering a first proximity event when the proximity is less than a first proximity threshold, the proximity event is the establishment of a connection, and the connection is of a first type, the first type selected from the group consisting of WiGig, WiDi, and Bluetooth CCF (Closed Communication Function). In one alternative, the first and second devices are not paired.

In one embodiment, a system for determining proximity of Bluetooth/Bluetooth Low Energy (BT/BLE) devices, in a connectionless session includes a first mobile device, the first mobile device configured to execute a contiguity profile, the contiguity profile providing for connectionless proximity determination. The first mobile device is further configured to determine a first proximity of a second device using Bluetooth/Bluetooth Low Energy (BT/BLE) protocol without establishing a Bluetooth/Bluetooth Low Energy (BT/BLE) connection to the second device. Optionally, the contiguity profile provides multidirectional proximity. Alternatively, the contiguity profile specifies that the first device is a proximity Reporter and a proximity Monitor concurrently. In one alternative, the contiguity profile specifies that as a proximity Reporter the first device advertises with advertisement messages and that as a proximity Monitor the first device scans for advertisement messages and determines first proximity based on advertisement messages. In one configuration, the first device functions as the proximity Monitor and receives a first advertisement message from the second device and based on the advertisement message determines the first proximity. In another alternative, the first device simultaneously functions as the proximity Reporter sends a second advertisement message to the second device and based on the advertisement message, the second device determines the proximity. Optionally, the first and second devices are not paired.

In another embodiment, a method of determining proximity of Bluetooth/Bluetooth Low Energy (BT/BLE) devices, in a connectionless session includes sending a first advertisement message from a first device, the sending utilizing a Bluetooth/Bluetooth Low Energy (BT/BLE) protocol. The method further includes receiving at a second device the first advertisement message and determining at the second device a proximity to the first device, the first and second device are not connected Bluetooth/Bluetooth Low Energy (BT/BLE) devices. Optionally, the method further includes sending a second advertisement message from the second device, the sending utilizing a Bluetooth/Bluetooth Low Energy (BT/BLE) protocol; receiving at the first device the second advertisement message; determining at the first device a proximity to the second device, where the first and second device are not paired Bluetooth/Bluetooth Low Energy (BT/BLE) devices and a Master and Slave status of the first and second device are not reconfigured from when the first advertisement message is sent.

In one embodiment, a computer-readable non-transitory storage medium that contains instructions, which when executed by one or more processors result in performing operations including executing a contiguity profile at a first device, the contiguity profile providing for connectionless proximity determination. The operations further include determining a proximity of a second device using Bluetooth/Bluetooth Low Energy (BT/BLE) protocol without establishing a Bluetooth/Bluetooth Low Energy (BT/BLE) connection to the second device. Optionally, the contiguity profile provides multidirectional proximity. Alternatively, the contiguity profile specifies that the first device is a proximity Reporter and a proximity Monitor concurrently. In one configuration, the contiguity profile specifies that as a proximity Reporter the first device advertises with advertisement messages and that as a proximity Monitor the first device scans for advertisement messages and determines proximity based on advertisement messages. Optionally, the first device functions as the proximity Monitor and receives an advertisement message from the second device and based on the advertisement message performs the determining.

The previous detailed description is of a small number of embodiments for implementing the systems and methods for Connectionless Proximity Determination and is not intended to be limiting in scope. The following claims set forth a number of the embodiments of the systems and the systems and methods for Connectionless Proximity Determination disclosed with greater particularity.

What is claimed:

1. A method of determining proximity of Bluetooth/Bluetooth Low Energy (BT/BLE) devices, in a connectionless session, the method comprising:
executing a contiguity profile at a first device, the contiguity profile providing for connectionless proximity determination; and
determining a proximity of a second device using Bluetooth/Bluetooth Low Energy (BT/BLE) protocol without establishing a Bluetooth/Bluetooth Low Energy (BT/BLE) connection to the second device.

2. The method of claim 1, wherein the contiguity profile provides multidirectional proximity.

3. The method of claim 1, wherein the contiguity profile specifies that the first device is a proximity Reporter and a proximity Monitor concurrently.

4. The method of claim 3, wherein the contiguity profile specifies that as a proximity Reporter the first device advertises with advertisement messages and that as a proximity Monitor the first device scans for advertisement messages and determines proximity based on advertisement messages.

5. The method of claim 4, wherein the first device functions as the proximity Monitor and receives an advertisement message from the second device and based on the advertisement message performs the determining.

6. The method of claim 1, further comprising:
triggering a first proximity event when the proximity is less than a first proximity threshold.

7. The method of claim 6, further comprising:
triggering a second proximity event when the proximity is greater than a second proximity threshold.

8. The method of claim 7, wherein the first proximity event is the activation of a system in the second device and the second proximity event is the deactivation of the system in the second device.

9. The method of claim 1, further comprising:
triggering a first proximity event when the proximity is less than a first proximity threshold;
triggering a second proximity event when the proximity is less than a second proximity threshold; and
triggering a third proximity event when the proximity is less than a third proximity threshold; wherein the second proximity threshold is closer to the second device than first proximity threshold and the third proximity threshold is closer to the second device than the second proximity threshold, and the first, second, and third proximity event relate to a wake up and activation of the second device.

10. The method of claim 6, further comprising:
triggering a first proximity event when the proximity is less than a first proximity threshold, wherein the proximity event is the establishment of a connection, wherein the connection is of a first type, the first type selected from the group consisting of WiGig, WiDi, and Bluetooth CCF (Closed Communication Function).

11. The method of claim 1, wherein the first and second device are not paired.

12. A system for determining proximity of Bluetooth/Bluetooth Low Energy (BT/BLE) devices, in a connectionless session, the system comprising:
a first mobile device, the first mobile device configured to
execute a contiguity profile, the contiguity profile providing for connectionless proximity determination; and
determine a first proximity of a second device using Bluetooth/Bluetooth Low Energy (BT/BLE) protocol without establishing a Bluetooth/Bluetooth Low Energy (BT/BLE) connection to the second device.

13. The system of claim 12, wherein the contiguity profile provides multidirectional proximity.

14. The system of claim 12, wherein the contiguity profile specifies that the first device is a proximity Reporter and a proximity Monitor concurrently.

15. The system of claim 14, wherein the contiguity profile specifies that as a proximity Reporter the first device advertises with advertisement messages and that as a proximity Monitor the first device scans for advertisement messages and determines first proximity based on advertisement messages.

16. The system of claim 15, wherein the first device functions as the proximity Monitor and receives a first advertisement message from the second device and based on the advertisement message determines the first proximity.

17. The system of claim 12, wherein the first and second device are not paired.

18. A computer-readable non-transitory storage medium that contains instructions, which when executed by one or more processors result in performing operations comprising:
executing a contiguity profile at a first device, the contiguity profile providing for connectionless proximity determination; and
determining a proximity of a second device using Bluetooth/Bluetooth Low Energy (BT/BLE) protocol without establishing a Bluetooth/Bluetooth Low Energy (BT/BLE) connection to the second device.

19. The medium of claim 18, wherein the operations further include instructions for the contiguity profile providing multidirectional proximity.

20. The medium of claim 18, wherein the operations further include instructions for the contiguity profile specifies that the first device is a proximity Reporter and a proximity Monitor concurrently.

21. The medium of claim 20, wherein the operations further include instructions for the contiguity profile specifies that as a proximity Reporter the first device advertises with advertisement messages and that as a proximity Monitor the first device scans for advertisement messages and determines proximity based on advertisement messages.

22. The medium of claim 21, wherein the operations further include instructions for the first device functions as the proximity Monitor and receives an advertisement message from the second device and based on the advertisement message performs the determining.
